(19) United States
(12) Patent Application Publication
(10) Pub. No.: US 2007/0042698 A1
(43) Pub. Date: Feb. 22, 2007

(54) Venting system and related method for a vehicle refrigerator

(76) Inventors: Jeffrey Negley, Covington, OH (US); Carl Onken, West Chester, OH (US)

Correspondence Address: HARNESS, DICKEY & PIERCE, P.L.C., P.O. BOX 828, BLOOMFIELD HILLS, MI, 48303, US

(21) Appl. No.: 11/207,062

(22) Filed: Aug. 18, 2005

(51) Int. Cl. B60H 1/00

(52) U.S. Cl. 454/139

(57) ABSTRACT

A venting system for a refrigerator of a vehicle having a roof top. The venting system includes a substantially continuous venting chamber defining a ventilation intake and a ventilation exhaust at the roof top.

Vehicles, including but not limited to recreational vehicles (“RVs” in the United States and “Caravans” in Europe), tractor trailers, airplanes, boats, trains, and the like, often incorporate refrigerators for the comfort and convenience of the occupants. These refrigerators are usually absorption-type refrigerators.

An absorption refrigerator includes a heat generator for heating a solution of refrigerant and an absorbent. Heat releases the refrigerant from the absorbent to form a high pressure refrigerant vapor. The refrigerant vapor is condensed in a cooling condenser. Low pressure solution from the heat generator is sprayed on the refrigerant vapor in an absorber to absorb the vapor. The absorption causes the pressure of the vapor to be reduced. Evaporation occurs in an evaporator between the condenser and the absorber. The refrigerant vapor expands in the evaporator which causes a temperature drop in the refrigerant. This temperature drop is used to provide cooling to the refrigerator. The solution of refrigerant and absorbent is then pumped back to the heat generator.

Airflow over the condenser and absorber is conventionally used for cooling of these elements. To create this airflow, which is also used to supply air for the combustion at the burner, a first duct or vent is conventionally provided through the vehicle wall for air intake. An exhaust is conventionally provided through a second duct or vent in the vehicle wall.

Another venting arrangement includes a lower vent assembly that provides ventilation intake, an upper vent assembly that provides ventilation exhaust, and a flue exhaust assembly that causes the combustion exhaust gases to mix with the ventilation air prior to being exhausted near the upper vent assembly and away from the refrigerator components. One such arrangement is shown in commonly assigned U.S. Provisional patent application Ser. No. 10/805,510. These applications are both hereby incorporated by reference herein.

Conventional venting arrangements for vehicle refrigerators provide air intake from the bottom of the vehicle with air exiting through the side or top of the vehicle, or air intake from the side of the vehicle with air exiting from the top of the vehicle. Such arrangements may restrict the choices of positioning the refrigerator relative to the floor plan of the vehicle, because they require access to a side wall or to a floor of the vehicle.

There is, therefore, a need for a vehicle refrigerator venting system that is efficient, cost-effective and provides more freedom in positioning the refrigerator relative to the floor plan of the vehicle.

### SUMMARY

The present teachings provide a venting system for a refrigerator of a vehicle having a roof top. The venting system includes a substantially continuous venting chamber defining a ventilation intake and a ventilation exhaust at the roof top of the vehicle.

The present teachings also provide a method for venting a refrigerator of a vehicle having a roof top. The method includes the steps of providing a venting chamber defining a ventilation intake and a ventilation exhaust at the roof top, and creating a ventilation flow from the ventilation intake to the ventilation exhaust for venting the refrigerator.

The present teachings also provide a venting system for a vehicle refrigerator. The venting system includes an intake duct defining a ventilation intake from the roof top of the vehicle, a plenum duct defining a ventilation exhaust at the roof top, and a connector coupling the intake and plenum ducts. The connector is adapted to create a ventilation flow from the ventilation intake to the ventilation exhaust for venting the refrigerator.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a partially exploded perspective view of a refrigerator incorporating a venting system according to the present teachings;

FIG. 2 is another partially exploded perspective view of a venting system according to the present teachings;

FIG. 3 is another partially exploded perspective view of a venting system according to the present teachings;

FIG. 4 is a front view of a venting system according to the present teachings;

FIG. 5 is an exploded perspective view of a venting system according to the present teachings;

FIG. 6 is a perspective environmental view of a venting system according to the present teachings; and

FIG. 7 is a side elevation environmental view of a venting system according to the present teachings, the venting system shown operatively associated with a vehicle.

### DETAILED DESCRIPTION

The following description is merely exemplary in nature and is in no way intended to limit the invention, its application, or uses.

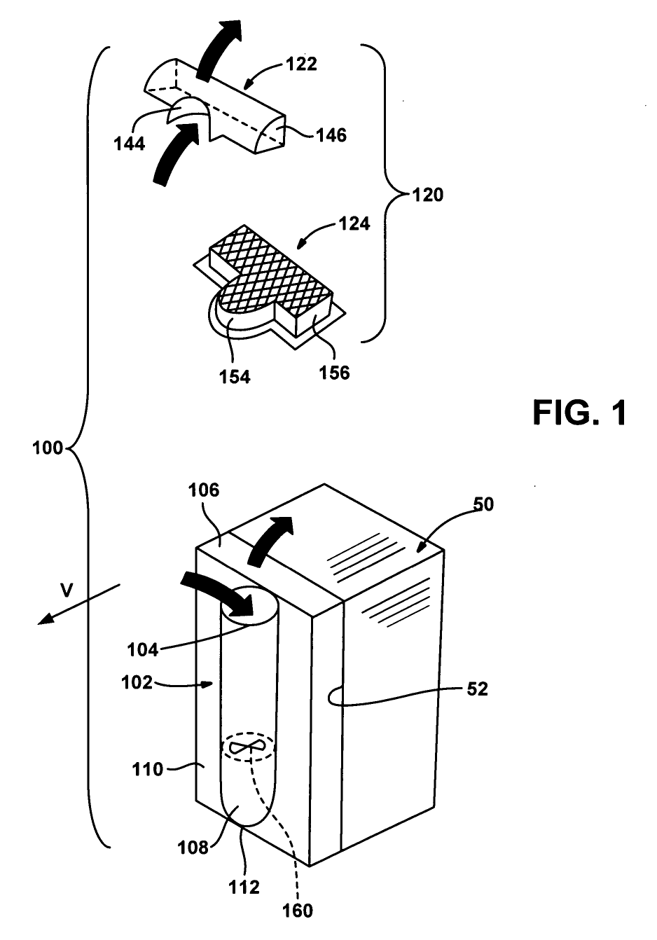

Referring to FIGS. 1 and 7, an exemplary venting system 100 according to the present teachings for a refrigerator 50 of a vehicle 40 is illustrated. The vehicle 40, which has a roof top 42 and a floor 46, can be a recreational vehicle (RV or caravan), a camping vehicle, or any other type of land, water, or air vehicle, in which the refrigerator 50 can be used. The refrigerator 50 is typically of the absorption type. The refrigerator 50 is shown throughout the drawings in simplified form: With the exception of the venting system 100 described herein, it will be understood that the refrigerator 50 is conventional insofar as the present invention is concerned.

The venting system 100 includes means for intaking a source of combustion air from the roof top 42 and means for venting exhaust gases to the roof top 46. The venting system 100 may include a venting chamber 102 coupled to the rear surface 52 of the refrigerator 50. The venting chamber 102 may be substantially U-shaped, and define a ventilation intake 104 and a ventilation exhaust 106, which are both vented at the roof top 42 of the vehicle 40 through a roof vent assembly 120. The vent assembly 120 may include a roof jack 122 and a roof jack base 124 coupled to the roof top 42.

The venting chamber 102 may include an intake duct 108 terminating at the ventilation intake 104 and a plenum duct 110 terminating at the ventilation exhaust 106. The intake duct 108 may be formed as a hollow tube coupled to the plenum duct 110 by an integral or modular connector 112. The plenum duct 110, which may be formed as a cover for the rear surface 52 of the refrigerator 50, encloses the cooling system of the refrigerator 50, including, for example, the condenser, the evaporator, the absorber and the heater, among other components that require ventilation and access to the atmosphere. The intake duct 108 with the connector 112 and the plenum duct 110 define the U-shape of the venting chamber 102.

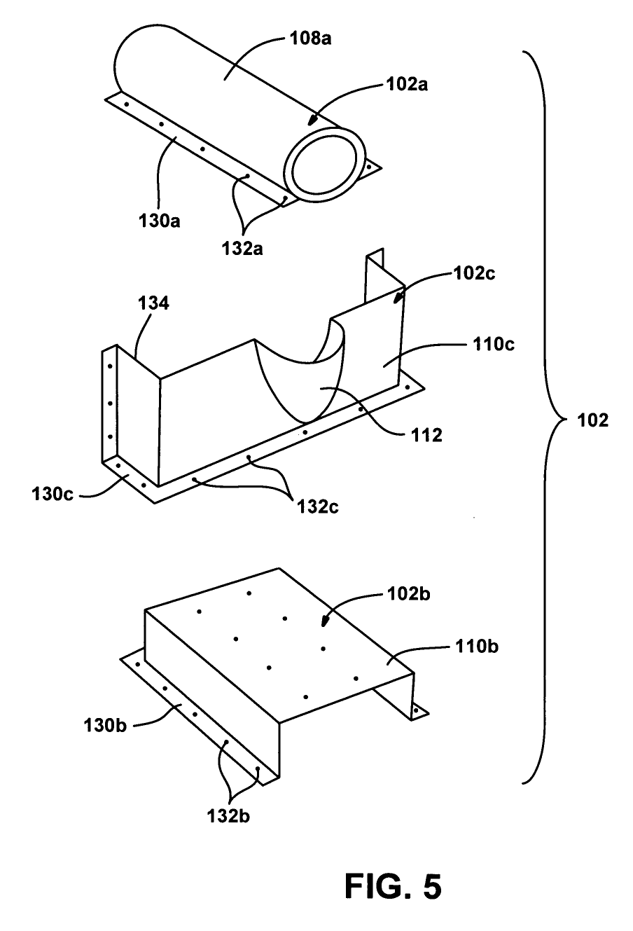

Referring to FIGS. 4 and 5, the venting chamber 102 may be modular, and may include, for example, first, second and third segments 102a, 102b and 102c. The first segment 102a includes an upper portion 108 of the intake duct 108, and a flange 130a. The first segment 102a may be manufactured, for example, by extrusion. Fastener holes 132a can be added to the flange 130a by a secondary operation. The second segment 102b includes an upper portion 110b of the plenum duct 110, and a flange 130b for attachment to the rear surface 52 of the refrigerator. The second segment 102b may be manufactured, for example, by vacuum forming. Fastener holes 132b may be added to the flange 130b by a secondary operation. The third segment 102c includes the connector 112 at the lower end of the intake duct 108, a lower portion 110c of the plenum duct 110, and a flange 130c for attachment to the rear surface 52 of the refrigerator. The third segment 102c may be manufactured, for example, by vacuum forming. Fastener holes 132c may be added to the flange 130c also by a secondary operation. The third segment 102c has an edge 134 that overlaps with a lower portion 136 of the second segment 102b. The third segment 102c may be removed to allow access to the back of the refrigerator for service or maintenance.

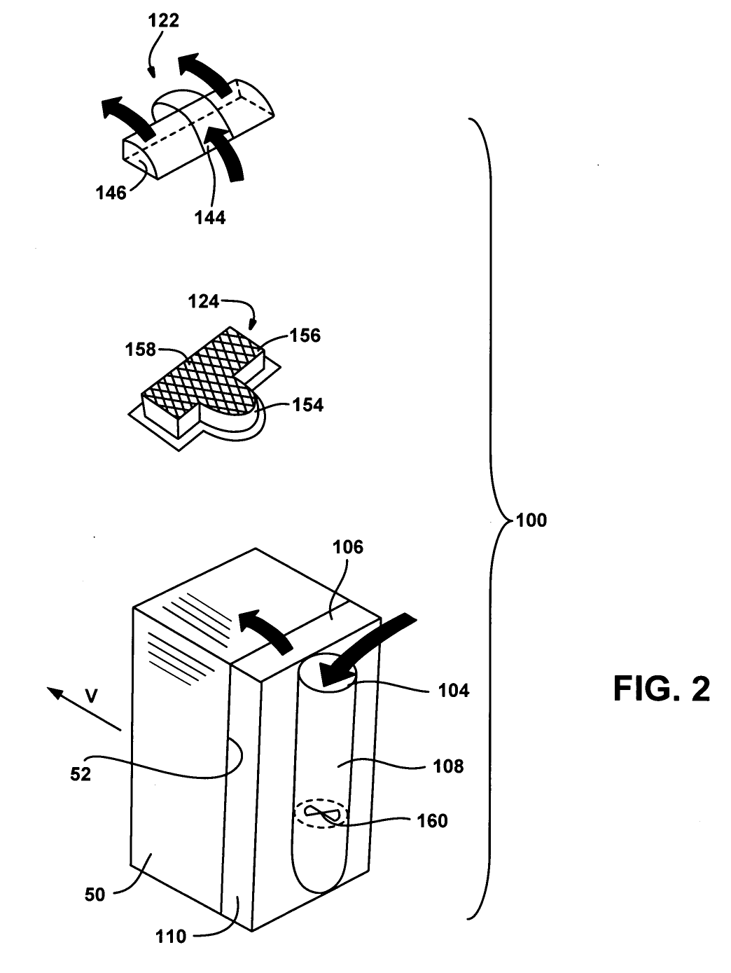

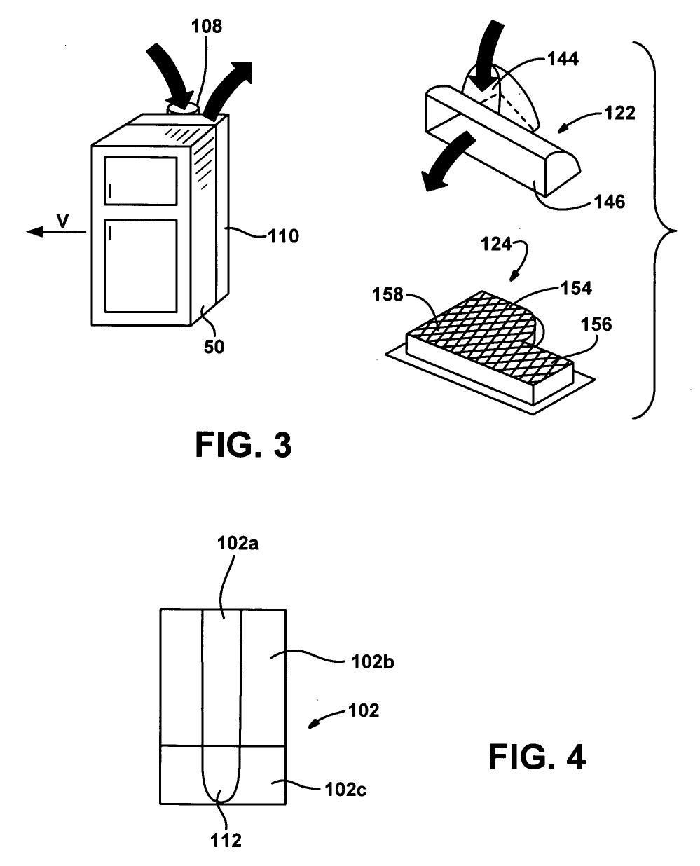

The venting chamber 102 allows the refrigerator 50 to be placed in any orientation relative to the floor plan of the vehicle 40. There is no need to place the refrigerator near a wall of the vehicle 40 because intake and exhaust venting are provided through the roof top 42. Accordingly, the refrigerator 50 can be placed facing the rear the vehicle 40, the front of the vehicle 40 or a side /isle of the vehicle 40. Representing the forward direction of the vehicle 40 by an arrow “V”, FIG. 1 illustrates the refrigerator 50 facing the rear of the vehicle 40, FIG. 2 illustrated the refrigerator 50 facing the front of the vehicle 40, and FIG. 3 illustrates the refrigerator 50 facing an isle of the vehicle 40, typically at an angle of 900 relative to the direction V.

Referring to FIGS. 1, 2 and 3, depending on the orientation of the refrigerator 50 relative to the floor plan of the vehicle 40, the roof vent assembly 120 may be advantageous adapted by design and/or orientation for efficient venting. Generally, the roof jack 122 includes an intake port 144 and an exhaust port 146. Similarly, the roof jack base 124 includes an intake opening 154 and an exhaust opening 156. The ventilation intake 104 of the venting chamber 102, the intake opening 154 of the roof jack base 124, and the intake port 144 of the roof jack 122 are aligned for unobstructed air flow from the outside of the vehicle 40 to the rear of the refrigerator 50. Similarly, the ventilation exhaust 106 of the venting chamber 102, the exhaust opening 156 of the roof jack base 124, and the exhaust port 146 of the roof jack 122 are aligned for unobstructed air flow from the rear of the refrigerator 50 to the outside of the vehicle 40.

To take advantage of the airflow generated by the forward motion of the vehicle 40 in the direction V, the intake port 144 can be directed to face the front of the vehicle 40, regardless of the orientation of the refrigerator 50 relative to the front of the vehicle 40. For example, three different roof jacks 122 can be provided corresponding to the three orientations illustrated in FIGS. 1-3, but only two different roof jack bases 124, because the same roof jack base 124 can be used (rotated 180°) for the orientations of FIGS. 1 and 2. Alternatively, the roof jack 122 and roof jack base 124 can be provided in modular form, having cylindrical parts 144, 154 and rectangular parts 146, 156 that can be oriented appropriately for each application. The roof jack base 124 can also be provided with a screen 158 to keep insects, leaves and other debris from entering the venting chamber 102.

Although air intake may be by natural flow while the vehicle 40 is stationary or moving, a fan or similar blower 160 may be provided to facilitate air flow. The fan 160 may be activated manually, or may be automatically activated as needed, based, for example, on the temperature of the cooling air passing through the plenum duct 110 over the rear surface 52 of the refrigerator. A commercially available sensor can be used for this purpose. Thus, venting air is pulled into the intake duct 108 by natural convection or by the fan 160 and is channeled by the connector 112 to the plenum duct 110, extracting heat and the products of combustion before exiting from the roof top 42 of the vehicle 40.

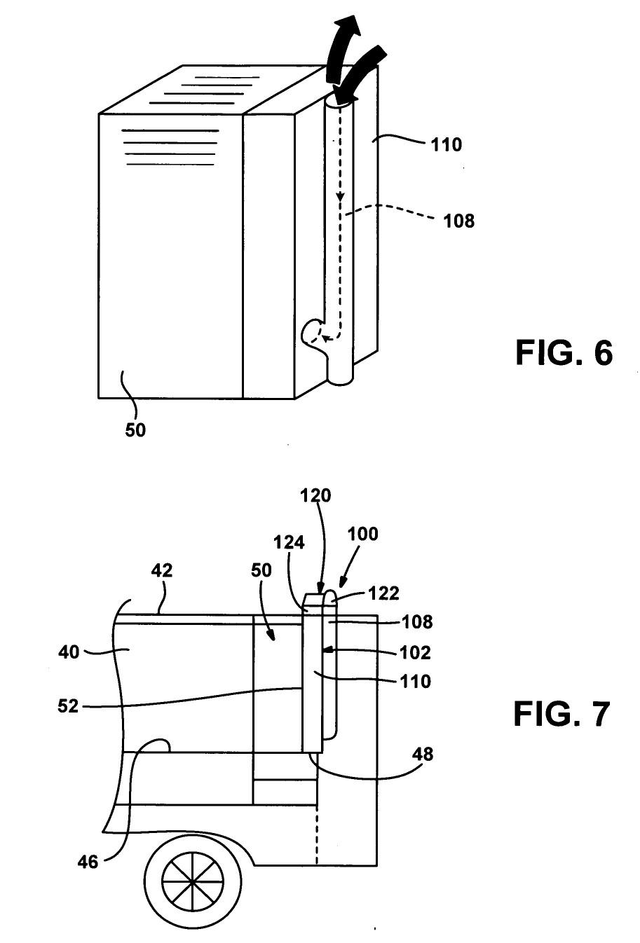

Referring to FIG. 1, the venting chamber 102 can be provided by the refrigerator's manufacturer together with the refrigerator 50 or as a separate accessory, and may be fastened to the rear surface 52 of the refrigerator 50 with fasteners, such as screws or bolts, as shown in FIG. 1. Alternatively, referring to FIG. 6, the manufacturer of the vehicle 40 may provide the plenum duct 110, and the refrigerator manufacturer can complete the venting chamber 102 by providing the intake duct 108. The intake duct 108 can be constructed, for example, from ordinary PVC pipe. The fan 160 can be mounted on the junction interface 170. One of the roof jack assemblies 120 of FIGS. 1-3, selected depending on the orientation of the refrigerator 50, can also be used in such construction.

Referring to FIG. 7, a small opening 48 can be made on the vehicle floor 46 under the venting chamber 102 to drain any water coming through the roof vent assembly 120, and to allow any fuel gas in the venting chamber, such as propane gas, which is heavier than air, to escape from the bottom of the venting chamber 102 through the opening 48.

The foregoing discussion discloses and describes merely exemplary arrangements of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A venting system for a refrigerator of a vehicle having a roof top, the venting system comprising:
means for intaking a source of combustion air from the roof top; and
means for venting exhaust gases to the roof top.

2. The venting system of claim 1, wherein the means for intaking a source of combustion air from the roof top includes an intake duct defining a ventilation intake at the roof top and wherein the means for venting exhaust gases to the roof top comprises a plenum duct defining a ventilation exhaust at the roof top.

3. The venting system of claim 2, further comprising a connector coupling the intake and plenum ducts, the connector adapted to create a ventilation flow from the ventilation intake to the ventilation exhaust for venting the refrigerator.

4. The venting system of claim 2, wherein the intake duct includes cylindrical tube portion.

5. The venting system of claim 2, wherein the plenum duct defines a refrigerator back cover.

6. The venting system of claim 3, wherein the connector is removably coupled to the intake and plenum ducts.

7. The venting system of claim 6, wherein the connector provides service access to the refrigerator.

8. The venting system of claim 2, further including a roof vent assembly.

9. The venting system of claim 8, wherein the roof vent assembly is adapted for a direction in which the refrigerator is facing relative to the vehicle.

10. The venting system of claim 9, wherein the direction can be any direction relative to a floor plan of the vehicle.

11. The venting system of claim 8, wherein the roof vent assembly includes a roof jack and a roof jack base.

12. The venting system of claim 2, further comprising a fan coupled to the intake duct.

13. The venting system of claim 12, wherein the fan is automatically actuated based on plenum air temperature.

14. The venting system of claim 3, wherein the intake duct, the plenum duct and the connector define a U-shaped venting chamber.

15. A method for venting a refrigerator of a vehicle having a roof top, the method comprising:
providing a venting chamber defining a ventilation intake and a ventilation exhaust at the roof top; and
creating a ventilation flow from the ventilation intake to the ventilation exhaust for venting the refrigerator.

16. The method of claim 15, further comprising selectively orienting a vent assembly for one of a forward facing orientation of the refrigerator, a rearward facing of the refrigerator, and a sideways facing orientation of the refrigerator.

17. A venting system for a refrigerator of a vehicle having a roof top, the venting system comprising:
a substantially continuous venting chamber defining a ventilation intake and a ventilation exhaust at the roof top.

18. The venting system of claim 17, wherein the venting chamber is substantially U-shaped.

19. The venting system of claim 17, further comprising a roof jack adapted for the ventilation intake and ventilation exhaust based on an orientation of the refrigerator relative to the vehicle.
